(19) United States
(12) Patent Application Publication
(10) Pub. No.: US 2026/0057472 A1
(43) Pub. Date: Feb. 26, 2026

(54) IMAGE PROCESSING METHOD AND APPARATUS, DEVICE, AND MEDIUM

(71) Applicant: Beijing Zitiao Network Technology Co., Ltd., Beijing (CN)

(72) Inventors: Zifan WANG, Beijing (CN); Lang CHEN, Beijing (CN)

(21) Appl. No.: 19/306,903

(22) Filed: Aug. 21, 2025

(30) Foreign Application Priority Data
Aug. 22, 2024 (CN) 202411162628.1

(51) Int. Cl. G06T 3/04; G06T 3/40; G06T 3/60; G06T 7/73; G06T 11/00

(52) U.S. Cl. CPC G06T 3/04; G06T 3/40; G06T 3/60; G06T 7/73; G06T 11/001; G06T 2207/20081

(57) ABSTRACT

The present disclosure provide an image processing method and apparatus, a device, and a medium. An embodiment of the method includes: obtaining an original image comprising a target object; determining, based on the original image, position information of a plurality of key points corresponding to the target object; obtaining a deformation coefficient that is set for the key points; and generating, based at least on the position information of the key points and the deformation coefficient, a target image corresponding to the original image according to a preset style, wherein the target image comprises a deformed object generated by performing stylization deformation on the target object.

### CROSS-REFERENCE TO RELATED APPLICATION(S)

The present disclosure claims the priority from the CN patent application No. 202411162628.1 entitled “Image processing method and apparatus, device, and medium” filed with the China National Intellectual Property Administration (CNIPA) on Aug. 22, 2024, the contents of which are hereby incorporated by reference in their entirety.

### FIELD

The present disclosure relates to the technical field of computers, in particular, to an image processing method and apparatus, a device and a storage medium.

### BACKGROUND

With the continuous development of image processing technology and machine learning technology, people can perform stylized processing on existing images using the machine learning method. For example, stylized conversion can be performed on a part of or all objects in a real image, to obtain a cartoon image.

### SUMMARY

The present disclosure provides an image processing method and apparatus, a device, and a medium.

In a first aspect, there is provided an image processing method, comprising:
obtaining an original image comprising a target object;
determining, based on the original image, position information of a plurality of key points corresponding to the target object;
obtaining a deformation coefficient that is set for the key points; and
generating, based at least on the position information of the key points and the deformation coefficient, a target image corresponding to the original image according to a preset style, wherein the target image comprises a deformed object generated by performing stylization deformation on the target object.

In a second aspect, there is provided an image processing apparatus, comprising:
a first obtaining module configured to obtain an original image comprising a target object;
a determining module configured to determine, based on the original image, position information of a plurality of key points corresponding to the target object;
a second obtaining module configured to obtain a deformation coefficient that is set for the key points; and
a generation module configured to generate, based at least on the position information of the key points and the deformation coefficient, a target image corresponding to the original image according to a preset style, wherein the target image comprises a deformed object generated by performing stylization deformation on the target object.

In a third aspect, there is provided a computer readable storage medium having a computer program stored thereon, wherein the computer program, when executed by the computer, causes the computer to perform the method in the first aspect as described above.

In a fourth aspect, there is provided an electronic device comprising a memory, a processor, and a computer program stored on the memory and operable on the processor, wherein the processor, when executing the program, performs the method in the first aspect as described above.

It would be appreciated that the foregoing general description and the following detailed description are provided only exemplarily and illustratively, without suggesting any limitation to the present disclosure.

### BRIEF DESCRIPTION OF THE DRAWINGS

In order to make clearer the technical solution according to the embodiments of the present disclosure, brief introduction of the drawings required in the embodiments will be provided below. Apparently, the drawings described below are only a part of the embodiments according to the present disclosure, and the ordinary skill in the art could derive other drawings on the basis of these drawings, without doing creative work.

FIG. 1 is a schematic diagram of an image processing scenario according to an example embodiment of the present disclosure;

FIG. 2 is a flowchart of an image processing method according to an example embodiment of the present disclosure;

FIG. 3A is a schematic diagram of an image processing scenario according to an example embodiment of the present disclosure;

FIG. 3B is a schematic diagram of a further image processing scenario according to an example embodiment of the present disclosure;

FIG. 3C is a schematic diagram of a still further image processing scenario according to an example embodiment of the present disclosure;

FIG. 3D is a schematic diagram of a still further image processing scenario according to an example embodiment of the present disclosure;

FIG. 3E is a schematic diagram of a still further image processing scenario according to an example embodiment of the present disclosure;

FIG. 3F is a schematic diagram of a still further image processing scenario according to an example embodiment of the present disclosure;

FIG. 4 is a flowchart of a further image processing method according to an example embodiment of the present disclosure;

FIG. 5 is a block diagram of an image processing apparatus according to an example embodiment of the present disclosure; and

FIG. 6 is a schematic block diagram of an electronic device provided by some embodiments of the present disclosure.

### DETAILED DESCRIPTION OF EMBODIMENTS

In order to enable those skilled in the art to better understand the technical solution according to the Description, clear and full description of the technical solution according to the embodiments described herein will be given below with reference to the accompanying drawings. Obviously, the embodiments described herein are only a part of the embodiments of the Description, rather than all of them. The ordinary skill in the art could derive other embodiments on the basis of the embodiments described herein, without doing creative work, which also fall into the protection scope of the Description.

In the following description of the accompanying drawings, the same symbols in different drawings represent the same or similar elements unless otherwise indicated. The implementations set forth in the following description of the example embodiments do not represent all the implementations consistent with the present disclosure. Instead, they are merely examples of apparatuses and methods consistent with some aspects of the present disclosure.

The terms as used herein are only for the purpose of describing particular embodiments, but should not be construed to limit the embodiments of the disclosure. As used herein, “a,” “said” and “the” in singular forms mean including plural forms, unless clearly indicated in the context otherwise. It should also be understood that, as used herein, the term “and/or” represents and contains any one and all possible combinations of one or more associated listed items.

It should be further understood that, although terms such as “first”, “second” and “third” are used herein for describing various elements, these elements should not be limited by these terms. These terms are only used for distinguishing one element from another element. For example, first information may also be called second information, and similarly, the second information may also be called the first information, without departing from the scope of the present disclosure. As used herein, the term “if” may be construed to mean “when”or “upon”or “in response to determining”, depending on the context.

With the continuous development of image processing technology and machine learning technology, people can perform stylized processing on existing images using the machine learning method. For example, stylized conversion can be performed on a part of or all objects in a real image, to obtain a cartoon image. In the related technologies, a generative adversarial network technology is typically used to generate a stylized image based on an existing original image. However, the generalized stylized image has a poor effect with respect to either the new style or the personalized features continued from the original image. Therefore, there arises a need for an image processing method.

The image processing solution provided by the present disclosure includes: determining position information of a plurality of key points corresponding to a target object included in an original image; generating, based at least on the position information of the key points and a deformation coefficient, a target image corresponding to the original image according to a preset style, wherein the target image includes a deformed object generated by performing stylization deformation on the target image. In this way, the deformed object in the target image has a specified style based on the target object in the original image, which expands the image generation method, enhances the image generation effect, and improves the user experience.

The technical solution provided by embodiments of the present disclosure may have the following beneficial effects:

The image processing method provided by embodiments of the present disclosure includes: determining position information of a plurality of key points corresponding to a target object included in an original image; generating, based at least on the position information of the key points and a deformation coefficient, a target image corresponding to the original image according to a preset style, wherein the target image includes a deformed object generated by performing stylization deformation on the target image. In this way, the deformed object in the target image has a specified style based on the target object in the original image, which expands the approaches for image generation, improves the effect of image generation, and improves the user experience.

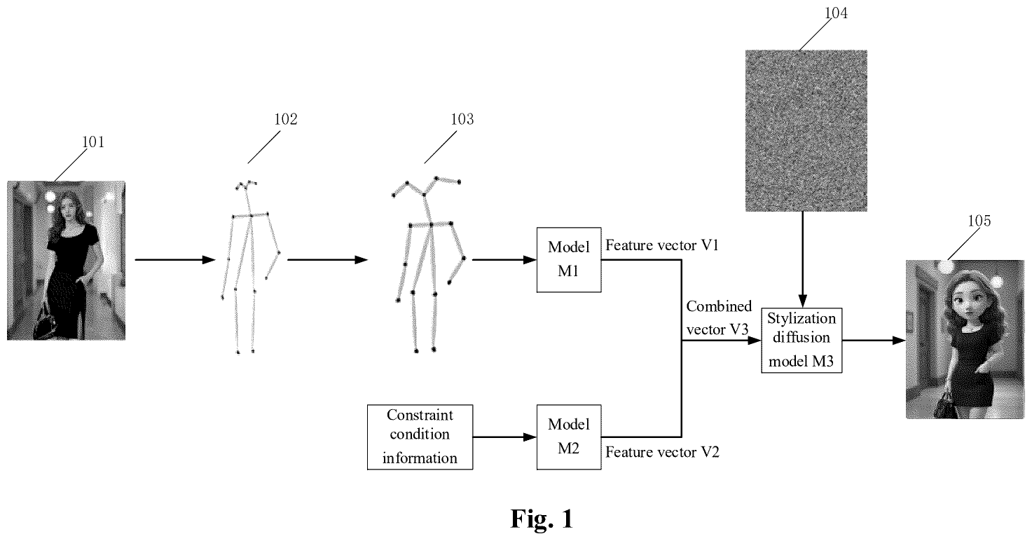

FIG. 1 is a schematic diagram of an image processing scenario according to an example embodiment.

As shown therein, an image 101 is an original image input by a user, wherein the original image includes a person. First of all, the image 101 is identified, to obtain position coordinates of human-body key points of the person in the image 101. Based on the position coordinates of the human-body key points, an image 102 is obtained, which is an original distribution map of the human-body key points of the person in the original image. Then, a deformation coefficient that is set for the key points can be obtained, which may be default to the system, or may be selected by the user based on an effect example image. The positions of the human-body key points in the image 102 are adjusted using the deformation coefficient, to thus obtain an image 103. A feature vector of the image 103 is then extracted using a pre-trained model M1, to obtain a feature vector V1. In addition, at least one piece of constraint condition information for the target object can be acquired, and a feature vector of the constraint condition information can be extracted using a pre-trained model M2, to obtain a feature vector V2. The feature vector V1 and the feature vector V2 are combined into a combined vector V3.

Random noise can be acquired, and a noisy image 104 is obtained based on the random noise and then input to a style diffusion model M3. The combined vector V3 is used as a conditional vector input to the style diffusion model M3, and as guided by the conditional vector, the style diffusion model M3 performs a multi-step denoising operation on the noisy image 104, to thus obtain an image 105. The image 105 has not only the specified style but also personalized features of the person in the image 101.

Hereinafter, reference will be made to the specific embodiments to describe in detail the present disclosure.

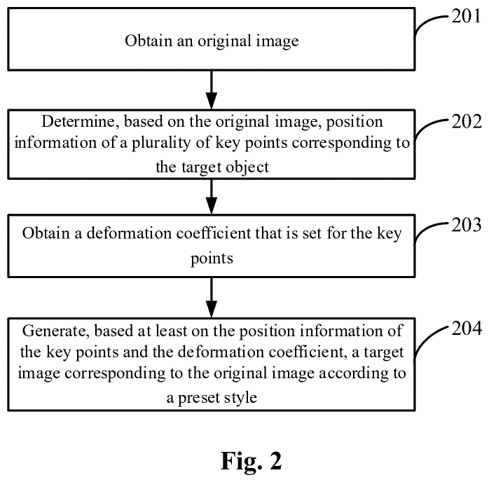

FIG. 2 is a flowchart of an image processing method according to an example embodiment. The method can be applied to a terminal device. In this embodiment, for ease of understanding, description will be made, with a terminal device capable of having a third-party application installed thereon as an example. As would be appreciated by those skilled in the art, the terminal device may include, but is not limited to, a mobile terminal such as a smart phone, a smart wearable device, a tablet computer, a laptop computer, a desktop computer, and the like. The method may include the following steps.

As shown therein, in step 201, an original image is obtained, and in step 202, position information of a plurality of key points corresponding to a target object is determined based on the original image.

In this embodiment, the original image may be an image selected and input by the user from a photo album, or an image immediately captured by the user using the camera function. The original image may include a target object which may be a person, an animal of a specified category (e.g. cat, dog, bird, fish, and the like), or may be an object of a specified type (e.g. tree, furniture, building, and the like). It would be appreciated that the specific type of the target object is not limited herein.

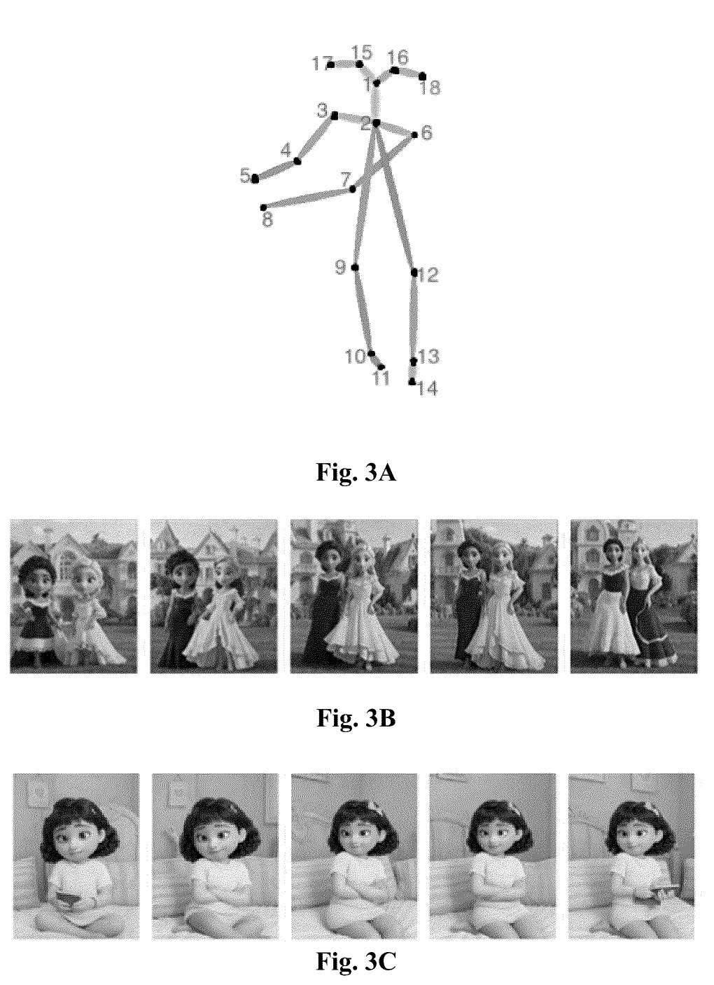

Following obtaining the original image, the original image can be analyzed, to identify position information of key points of the target object in the original image, wherein the position information may be, for example, coordinate information, and the like. The computer vision technology and a deep learning model can be used to detect position information of a plurality of key points corresponding to the target object. Wherein, if the target object is a person or an animal, key points corresponding to the target object may be human-body key points, skeleton key points, posture key points, or the like. The specific type of the key points is not limited herein. A person is taken as an example of the target object. FIG. 3A is a schematic diagram of identifying and obtaining human-body key points.

In step 203, a deformation coefficient that is set for the key points is obtained.

In the embodiment, if the target object includes a person, or an animal of a specified category, the deformation coefficient can be used for adjusting a head-to-body ratio corresponding to the target object, and/or adjusting a posture corresponding to the target object. The deformation coefficient can be set for key points, and the positions of the key points can be adjusted based on the deformation coefficient, so as to adjust the head-to-body ratio or the posture of the target object. Since there are multiple key points, deformation coefficients can be set respectively for a part or all of the multiple key points.

In an implementation, the system may include a set of default deformation coefficients that correspond to a specified head-to-hair ratio or a posture. The set of default deformation coefficients include different deformation coefficients for different key points. The default deformation coefficients of the system can be directly acquired for adjusting the positions of the key points.

In a further implementation, a plurality of sets of different deformation coefficients can also be set for a plurality of types of head-to-body ratios and postures, wherein each set of deformation coefficients corresponds to a head-to-body ratio or a posture. Then, a plurality of sets of different deformation coefficients can be displayed as image examples, for user's selection. FIG. 3B shows different image effects correspond to different head-to-body ratios. FIG. 3C shows different image effects correspond to different postures. FIG. 3D shows corresponding different image effects when both the head-to-body ratio and the posture are different.

For example, for the head-to-body ratio a1: b1, a set of corresponding deformation coefficients C1 can be set; for the head-to-body ratio a2: b2, a set of corresponding deformation coefficients C2 can be set; and for the head-to-body ratio a3: b3, a set of corresponding deformation coefficients C3 can be set. Then, an image example P1 with the head-to-body ratio a1: b1, an image example P2 with the head-to-body radio a2: b2, and an image example P3 with the head-to-body ratio a3: b3 are displayed to the user, such that the user can intuitively acquire the image effects under different head-to-body ratios, and select the corresponding deformation coefficient based on the image example. For example, the user can trigger a select button associated with the image example P1, and thus select and obtain the deformation coefficient C1.

In step 204, based on the position information of the key points and the deformation coefficient, a target image corresponding to the original image is generated according to a preset style.

In this embodiments, based on the position information of the key points and the deformation coefficient, a target image can be generated according to a preset style, wherein the target image may include a deformed object generated by performing stylization deformation on the target object. In the case, the deformed object has both personalized features of the target object in the original image but also the specified stylized features. For example, the deformed object may be a cartoon image of a specified style obtained based on a real portrait, or the like.

Specifically, the position information of the key points can be adjusted based on the default deformation coefficient of the system, or the deformation coefficient selected by the user. Thereafter, a target key point distribution map is obtained based on the position information of the adjusted key points, and based at least on the target key point distribution map, the target image is generated according to the preset style.

In this embodiment, a specific scenario may be that: a user takes an image P of a person standing next to a building, and then inputs the image P into an application for image processing. The user can browse effect images with different head-to-body ratios and/or postures through the processing interface, and determine the corresponding deformation coefficient according to the effect image. Then, a new image T can be generated based on the image P, using the deformation coefficient. The image T may be a cartoon image of a princess style. The image T includes a cartoon character of a princess standing next to a castle, which is deformed from the person in the image P, and a castle which is a deformed product of the building in the image P. Moreover, the character in the image T has the personalized features of the person in the image P.

In addition to the application scenario described above, the embodiment can be applied to other scenarios. The image processing method provided by the present disclosure includes: determining position information of a plurality of key points corresponding to a target object included in an original image; generating, based at least on the position information of the key points and a deformation coefficient, a target image corresponding to the original image according to a preset style, wherein the target image includes a deformed object generated by performing stylization deformation on the target image. In this way, the deformed object in the target image has a specified style based on the target object in the original image, which expands the image generation method, enhances the image generation effect, and improves the user experience.

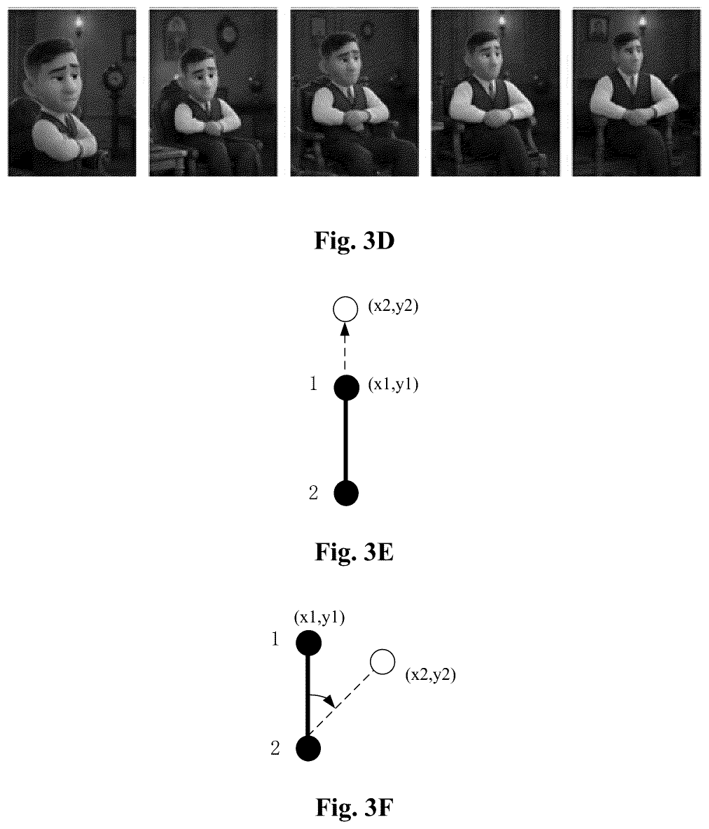

FIG. 4 is a flowchart of a further image processing method according to an example embodiment. In the embodiment, a process of generating the target image corresponding to the original image in step 204 is described, including the following steps:

As shown therein, in step 401, the position information of the key points is adjusted based on the deformation coefficient.

In this embodiment, the deformation coefficient may have two dimensions, wherein one dimension is a scaling coefficient for the key points, and the other dimension is a rotation coefficient for the key points. Specifically, the key points can be connected, to obtain line segments, and the line segments are classified; a uniform deformation coefficient can be set in advance for each type of line segments, to adjust the positions of the key points included in different types of line segments.

The human-body key points are taken as an example. Referring to FIG. 3A, there are 18 human-body key points from No. 1 to No. 18 that are connected, and the line segments therebetween can be divided into the following types: head, neck, shoulder, arm, torso, and leg. Wherein, the line segment 1-15, the line segment 1-16, the line segment 15-17, and the line segment 16-18 are line segments of the head type; the line segment 1-2 is a line segment of the neck type; the line segment 2-3, and the line segment 2-6 are the line segments of the shoulder type; the line segment 3-4, the line segment 4-5, the line segment 6-7, and the line segment 7-8 are line segments of the arm type; the line segment 2-9, and the line segment 2-12 are line segments of the torso type; the line segment 9-10, the line segment 10-11, the line segment 12-13, and the line segment 13-14 are line segments of the leg type. With the key point No. 2 as a reference point, the coordinate position of this point is fixed, and the positions of other key points are adjusted based on the deformation coefficients and these line segments between the human-body key points.

Specifically, on one hand, a dimension of the deformation coefficient is a scaling coefficient for the key points, and with the reference point having the fixed position as a center, the positions of the key points are updated one by one from the inside to the outside. FIG. 3A is taken here as an example. The key point No. 1, the key point No. 3, and the key point No. 6 directly connected with the key point No. 2 can be updated first. For example, the line segment 1-2 is of the neck type. A scaling coefficient α1 set for the neck type can be acquired, and scaling processing is performed on the segment 1-2 based on the scaling coefficient 1-2. Since the key point No. 2 is a reference point with a fixed position, the key point No. 2 acts as a fixed end of the line segment 1-2, and it is only required to move, based on the scaling coefficient α1, the position of the key point No. 1 along a straight-line direction where the line segment is located. As shown in FIG. 3E, the coordinates of the initial position of the key point No. 1 are (x1, y1), and after performing the scaling processing based on the scaling coefficient α1, the coordinates of the position of the key point No. 1 are updated to (x2, y2), and so on. The key points No. 3 and No. 6 can be scaled and updated likewise. Next, the key point No. 15, the key point No. 16, the key point No. 4 and the key point No. 7, which are directly connected with the key point No. 1, the key point No. 3 and the key point No. 6, are updated, and so on, until all the key points are updated. It is worth noting that the updated key points all have fixed coordinates, and need not be updated again. For example, after the coordinates of the key point No. 1 have been updated, only the coordinates of the key point No. 15 are updated when the line segment 1-15 is updated, with the key point No. 1 being the fixed end of the line segment 1-15.

On the other hand, the other dimension of the deformation coefficient is a rotation coefficient for the key points, i.e., with the reference point having a fixed position as the center, the positions of the key points are updated one by one from the inside to the outside. FIG. 3A is still taken as an example. The key point No. 1, the key point No. 3 and the key point No. 6 directly connected with the key point No. 2 are updated first. For example, the line segment 1-2 is of the neck type. A rotation coefficient α2 set for the neck type can be acquired, and rotation processing is performed on the line segment 1-2 based on the rotation coefficient α2. Since the key point No. 2 is a reference point with a fixed position, the key point No. 2 is the fixed end of the line segment 1-2, and it is only required to rotate, based on the rotation coefficient α2, the key point No. 1 about the key point 1. As shown in FIG. 3F, the coordinates of the initial position of the key point No. 1 are (x1, y1), and after the rotation processing is performed based on the rotation coefficient α2, the coordinates of the position of the key point No. 1 are updated to (x3, y3), and so on. The key point No. 3 and the key point No. 6 are rotated and updated likewise. Then, the key point No. 15, the key point No. 16, the key point No. 4 and the key point No. 7, which are directly connected with the key point No. 1, the key point No. 3 and the key point No. 6, are updated, and so on, until all the key points are updated. It is worth noting that the updated key points all have fixed coordinates, and need not be updated again. For example, after the coordinates of the key point No. 1 have been updated, only the coordinates of the key point No. 15 are updated when the line segment 1-15 is updated, with the key point No. 1 being the fixed end of the line segment 1-15.

In step 402, a target key point distribution map is obtained based on the position information of the adjusted key points.

In an implementation, based on the position information of the adjusted key points, a key point distribution map can be generated directly as a target key point distribution map. In a further implementation, an initial key point distribution map can also be generated based on the position information of the adjusted key points. Subsequently, the initial key point distribution map is cropped based on a preset aspect ratio and a preset proportion of a blank area, to obtain the target key point distribution map. In this way, the distribution of the updated key points in the target key point distribute map is more reasonable.

In step 403, based at least on the target key point distribution map, a target image is generated according to a preset style.

In an implementation, based on the target key point distribution map, a target image can be generated directly based on the target key point distribution map. In a further implementation, constraint condition information for the target object can be further acquired, and a target image can be generated based on the constraint condition information and the target key point distribution map, according to the preset style. Wherein, the constraint condition information can be obtained based on some personalized features of the target object in the original image.

In this embodiment, the constraint condition information may include, but is not limited to: at least one type of specified style information for the target object, contour information corresponding to the target object, skin color information/pelage color information corresponding to the target object, hair color information corresponding to the target object, and a face feature corresponding to the target object. Wherein, the specified style information for the target object may include, but is not limited to, a style characterizing an emotion of the target object, a style characterizing clothing of the target object, a style characterizing an occupation of the target object, and the like.

Specifically, a pre-trained model can be used to identify and extract constraint condition information for the target object from the original image, or a computer vision technology can be used to identify constraint condition information for the target object from the original image, and provide the user a text input interface, to prompt the user to input the constraint condition information for the target object via the text input interface. It would be appreciated that the constraint condition information for the target object can be acquired in any other appropriate and reasonable way, which is not limited in the embodiment.

After obtaining the constraint condition information, the target image can be generated based on the constraint condition information and the target key point distribution map, according to the preset style. Specifically, a pre-trained first model can be used to extract a first feature vector of the constraint condition information, a pre-trained second model can be used to extract a second feature vector of the target key point distribution map, and the first feature vector and the second feature vector can be combined into a combined vector. The combined vector can be used as a condition vector for guiding the generation of the target image, and a style diffusion model trained for a preset style can be used to generate the target image. Wherein, the style diffusion model can be pre-trained for a preset style, and different style diffusion models can thus be trained for various different styles. A selection interface can be provided to the user, to enable the user to select a target style, and a style diffusion model corresponding to the target style selected by the user can be used to generate a target image of the target style.

Since the position information of the key points are adjusted based on the deformation coefficient in the embodiment, a target key point distribution map can be obtained based on the position information of the adjusted key points, and based at least on the target key point distribution map, a target image can be generated according to the preset style. In this way, the deformed object in the target image has not only the specified style but also more personalized features of the target object in the original image, which can further enhance the effect of the generated image, and improve the user experience.

It would be appreciated that, although the operations of the method according to the embodiments of the present disclosure are depicted above in a particular order, this does not require or hint that such operations should be performed in the particular order, or all the operations shown should be performed to achieve the desired result. Instead, the steps depicted in the flowchart can be performed in a different order. In addition, or alternatively, some steps may be omitted, and a plurality of steps can be combined as one step, and/or a step can be divided into a plurality of steps.

Corresponding to the embodiments about the image processing method described above, the present disclosure further provides embodiments about an image processing apparatus.

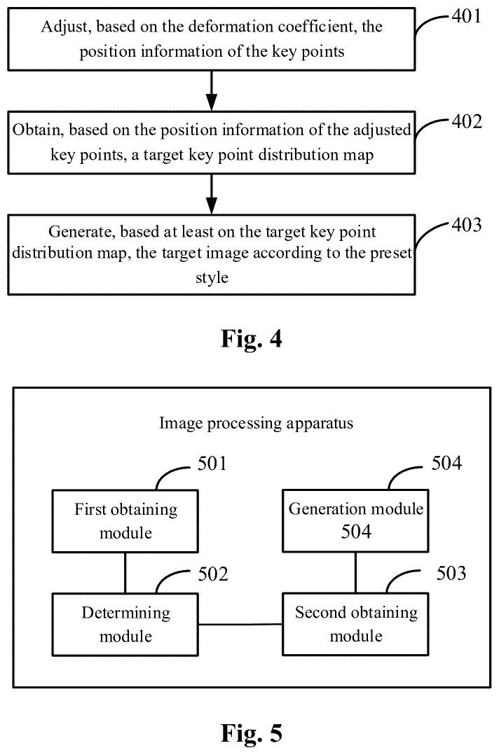

FIG. 5 is a block diagram of an image processing apparatus according an example embodiment of the present disclosure. The apparatus includes: a first obtaining module 501, a determining module 502, a second obtaining module 503, and a generation module 504.

Wherein, the first obtaining module 501 is configured to obtain an original image comprising a target object.

The determining module 502 is configured to determine, based on the original image, position information of a plurality of key points corresponding to the target object.

The second obtaining module 503 is configured to obtain a deformation coefficient that is set for the key points.

The generation module 504 is configured to generate, based at least on the position information of the key points and the deformation coefficient, a target image corresponding to the original image according to a preset style, wherein the target image includes a deformed object generated by performing stylization deformation on the target object.

In some implementations, the target object comprises a person or an animal of a specified type, and the deformation coefficient is used for adjusting a head-to-body ratio corresponding to the target object, and/or a posture corresponding to the target object.

In some other implementations, the generation module 504 may include: an adjustment sub-module, an obtaining sub-module, and a generation sub-module (not shown).

Wherein, the adjustment sub-module is configured to adjust, based on the deformation coefficient, the position information of the key points.

The obtaining sub-module is configured to obtain, based on the position information of the adjusted key points, a target key point distribution map.

The generation sub-module is configured to generate, based at least on the target key point distribution map, the target image according to the preset style.

In some other implementations, the deformation coefficient comprises a scaling coefficient for the key points, and/or a rotation coefficient for the key points.

In some other implementations, the obtaining sub-module is configured to generate, based on the position information of the adjusted key points, an initial key point distribution map; and crop, based on a preset aspect ratio and a preset proportion of a blank area, the initial key point distribution map to obtain the target key point distribution map.

In some other implementations, the generation sub-module is configured to: obtain constraint condition information for the target object; and generate, based on the constraint condition information and the target key point distribution map, the target image according to the preset style.

In some other implementations, the constraint condition information comprises one or more of the following: at least one type of specified style information for the target object, contour information corresponding to the target object, skin color information/pelage color information corresponding to the target object, hair color information corresponding to the target object, and a face feature corresponding to the target object.

In some other implementations, the generation sub-module generates, based on the constraint condition information and the target key point distribution map, the target image according to the preset style, in such manner of: extracting a first feature vector of the constraint condition information using a pre-trained first model; extracting a second feature vector of the target key point distribution map using a pre-trained second model; combining the first feature vector with the second feature into a combined vector; and generating the target image using a style diffusion model trained for a preset style and using the combined vector as a conditional vector.

Since the apparatus embodiments substantially correspond to the method embodiments, see the description of the embodiment embodiments for the details of the related parts. The apparatus embodiments described above are provided only as an example, wherein units described above as separate components may not be physically separated, and components displayed as a unit may, or may not, be a physical unit (i.e., they are located at the same part), or may be distributed over a plurality of network units. A part of or all the modules can be selected as actually required, to accomplish the objective of the solution according to the embodiments of the present disclosure. The ordinary skill in the art could understand and carry out the present disclosure, without doing creative work.

Some embodiments of the present disclosure provide an electronic device. The electronic device includes a processor and a memory, which can be used to implement a client or a server. The memory is used to store computer-executable instructions (e.g. one or more computer program modules) in a non-transitory manner. The processor is used to run the computer-executable instructions that, when run by the processor, can perform one or more steps of the image processing method as described above, to thus implement the image processing method. The memory and the processor can be interconnected via a bus system, and/or a connection mechanism in other form (not shown).

For example, the processor may be a Central Processing Unit (CPU), a Graphics Processing Unit (GPU), or other processing unit with a data processing capability and/or a program execution capability. For example, the Central Processing Unit (CPU) may be of an X86 or ARM architecture, or the like. The processor may be a general purpose processor, or a special purpose processor, which can control other components in the electronic device to perform desired functions.

For example, the memory may be one or more computer program products, wherein the computer program product may include various forms of computer-readable storage media, such as volatile memory and/or a non-volatile memory. The volatile memory may include, for example, a Random Access Memory (RAM) and/or cache, or the like. The non-volatile memory may include, for example, a Read-Only Memory (ROM), a hard disk, an Erasable Programmable Read-Only Memory (EPROM), a portable Compact Disc Read-Only Memory (CD-ROM), a USB memory, a flash memory, and the like. The computer readable storage medium may have one or more computer program modules stored thereon, and the processor can run one or more computer program modules to implement various functions of the electronic device. The computer readable storage medium may store therein various applications and data, and various data used and/or generated by the applications.

For the specific functions and technical effects of the electronic device in the embodiment of the present disclosure, see the description of the image processing method described above. The details thereof omitted herein.

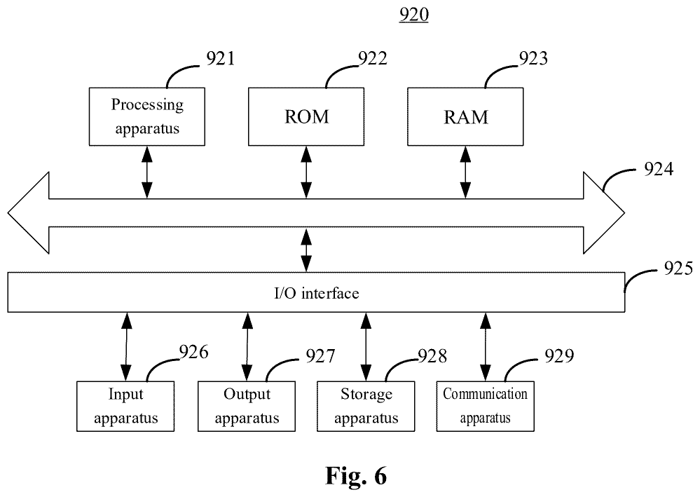

FIG. 6 is a schematic block diagram of a further electronic device provided by some embodiments of the present disclosure. The electronic device 920 is adapted to, for example, implement the image processing method provided by embodiments of the present disclosure. The electronic device 920 may be a terminal device, or the like, and can be used to implement a client or a server. The electronic device 920 may include, but is not limited to, a mobile terminal such as a mobile phone, a laptop computer, a digital broadcast receiver, a PDA (Portable Multimedia Player), an on-vehicle terminal (e.g. an on-vehicle navigation terminal), a wearable electronic device, or the like, and a fixed terminal such as a digital TV, a desktop computer, a smart household device, or the like. The electronic device 920 shown in FIG. 6 is only provided as an example, without suggesting any limitation to the function and the scope of use of the embodiments of the present disclosure.

As shown therein, the electronic device 920 may include a processing device (e.g. a central processor, a graphics processor or the like) 921, which can execute various acts and processing based on programs stored in a Read-Only Memory (ROM) 922 or a program loaded from a storage apparatus 928 to a Random Access Memory (RAM) 923. RAM 923 stores therein various programs and data required for operations of the electronic device 920. The processing apparatus 921, the ROM 922, and the RAM 9233 are connected to one another via a bus 924. An input/output (I/O) interface 925 is also connected to the bus 924.

Typically, the following units may be connected to the I/O interface 925: an input apparatus 926 including, for example, a touchscreen, a touch pad, a keyboard, a mouse, a camera, a microphone, an accelerometer, a gyroscope, and the like; an output apparatus 927 including, for example, a Liquid Crystal Display (LCD), a loudspeaker, a vibrator, and the like; a storage apparatus 928 including, for example, a tape, a hard drive, and the like; and a communication apparatus 929. The communication apparatus 929 can allow wireless or wired communication of the electronic device 920 with other devices to exchange data. Although FIG. 6 shows the electronic device 920 including various apparatuses, it would be appreciated that not all of the apparatuses as shown are required to be implemented or provided. Alternatively, the electronic device 920 may implement or include more or fewer apparatuses.

According to embodiments of the present disclosure, the image processing method can be implemented as computer software programs. For example, embodiments of the present disclosure include a computer program product comprising computer programs carried on a computer readable medium, wherein the computer programs contain program code for performing the image processing method as described above. In those embodiments, the computer programs may be downloaded and installed from a network via the communication apparatus 929, or may be installed from the storage apparatus 928, or may be installed from the ROM 922. The computer programs, when executed by the processing apparatus 921, perform the above-described functions defined in the image processing method according to the embodiments of the present disclosure.

The embodiments of the present disclosure provide a computer storage medium. For example, the storage medium may be a non-transitory computer-readable storage medium for storing non-transitory computer-executable instructions. When executed by the processor, the non-transitory computer-executable instructions can implement the image processing method according to the embodiments of the present disclosure. For example, when executed by the processor, the non-transitory computer-executable instructions can perform one or more steps of the image processing method as described above.

The storage medium can be applied in the electronic device described above. For example, the storage medium may include a memory in the electronic device.

The storage medium may include a memory card for a smart phone, a storage component for a tablet computer, a hard disk of a personal computer, a Random Access Memory (RAM), a Read-Only Memory (ROM), an Erasable Programmable Read-Only Memory (EPROM), a portable Compact Disc Read-Only Memory (CD-ROM), a flash memory, or any combination of the foregoing, or may be other suitable memory medium.

For the storage medium, see the description of the memory in the embodiments about the electronic device, and details thereof are omitted for brevity. For the specific function and technical effect of the storage medium, see the description of the image processing method, and details thereof are omitted for brevity.

In the context of this disclosure, a machine-readable medium may be a tangible medium that can contain or store a program for use by or in connection with an instruction execution system, apparatus, or device. The computer readable medium according to the present disclosure may be a computer readable signal medium or a computer readable storage medium or any combination of the two. The computer readable storage medium may be, for example, but not limited to, an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer diskette, a hard disk, a Random Access Memory (RAM), a Read-Only Memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, a computer readable storage medium may be any tangible medium that can contain, or store, a program for use by or in connection with an instruction execution system, apparatus, or device. In contrast, in the present disclosure, a computer readable signal medium may include a propagated data signal with computer readable program code embodied therein, either in baseband or as part of a carrier wave. Such propagated data signal may take many forms, including, but not limited to, an electro-magnetic signal, an optical signal, or any suitable combination thereof. A computer readable signal medium may also be any computer readable medium that is not a computer readable storage medium and that can communicate, propagate, or transmit a program for use by or in connection with an instruction execution system, apparatus, or device. Program code embodied on a computer readable medium may be transmitted using any appropriate medium, including but not limited to: electrical wires, optical cables, RF (radio frequency), etc., or any suitable combination of the foregoing.

Having considered the Description or carried out the present disclosure, those skilled in the art would easily envision other embodiments of the present disclosure. The present disclosure intends to cover any variations, uses, or adaptive changes which follow the general principles of the present disclosure, and encompass common knowledge or customary technical means in the art which is not disclosed herein. The Description and the embodiments described therein are only provided exemplarily, and the actual scope and spirit of the present disclosure are set forth in the appended claims.

It would be appreciated that the present disclosure is not confined to the precise structures described above and shown in the accompanying drawings, which allows various modifications and changes without departing from the scope thereof. The scope of the present disclosure is defined only by the appended claims.

I/We claim:

1. An image processing method, comprising:
obtaining an original image comprising a target object;
determining, based on the original image, position information of a plurality of key points corresponding to the target object;
obtaining a deformation coefficient that is set for the key points; and
generating, based at least on the position information of the key points and the deformation coefficient, a target image corresponding to the original image according to a preset style, wherein the target image comprises a deformed object generated by performing stylization deformation on the target object.

2. The method of claim 1, wherein the deformation coefficient is used for adjusting a head-to-body ratio corresponding to the target object, and/or a posture corresponding to the target object.

3. The method of claim 1, wherein generating, based at least on the position information of the key points and the deformation coefficient, the target image corresponding to the original image according to the preset style comprises:
adjusting, based on the deformation coefficient, the position information of the key points;
obtaining, based on the position information of the adjusted key points, a target key point distribution map; and
generating, based at least on the target key point distribution map, the target image according to the preset style.

4. The method of claim 3, wherein the deformation coefficient comprises a scaling coefficient for the key points, and/or a rotation coefficient for the key points.

5. The method of claim 3, wherein obtaining, based on the position information of the adjusted key points, the target key point distribution map comprises:
generating, based on the position information of the adjusted key points, an initial key point distribution map; and
cropping, based on a preset aspect ratio and a preset proportion of a blank area, the initial key point distribution map to obtain the target key point distribution map.

6. The method of claim 3, wherein generating, based at least on the target key point distribution map, the target image according to the preset style comprises:
obtaining constraint condition information for the target object; and
generating, based on the constraint condition information and the target key point distribution map, the target image according to the preset style.

7. The method of claim 6, wherein the constraint condition information comprises one or more of the following: at least one type of specified style information for the target object, contour information corresponding to the target object, skin color information/pelage color information corresponding to the target object, hair color information corresponding to the target object, and a face feature corresponding to the target object.

8. The method of claim 6, wherein generating, based on the constraint condition information and the target key point distribution map, the target image according to the preset style comprises:
extracting a first feature vector of the constraint condition information using a pre-trained first model;
extracting a second feature vector of the target key point distribution map using a pre-trained second model;
combining the first feature vector with the second feature to obtain a combined vector; and
generating the target image using a style diffusion model trained for a preset style and using the combined vector as a conditional vector.

9. A non-transitory computer readable storage medium having a computer program stored thereon, wherein the computer program, when executed on a computer, causes the computer to perform an image processing method comprising:
obtaining an original image comprising a target object;
determining, based on the original image, position information of a plurality of key points corresponding to the target object;
obtaining a deformation coefficient that is set for the key points; and
generating, based at least on the position information of the key points and the deformation coefficient, a target image corresponding to the original image according to a preset style, wherein the target image comprises a deformed object generated by performing stylization deformation on the target object.

10. The non-transitory computer readable storage medium of claim 9, wherein the deformation coefficient is used for adjusting a head-to-body ratio corresponding to the target object, and/or a posture corresponding to the target object.

11. The non-transitory computer readable storage medium of claim 9, wherein generating, based at least on the position information of the key points and the deformation coefficient, the target image corresponding to the original image according to the preset style comprises:
adjusting, based on the deformation coefficient, the position information of the key points;
obtaining, based on the position information of the adjusted key points, a target key point distribution map; and
generating, based at least on the target key point distribution map, the target image according to the preset style.

12. The non-transitory computer readable storage medium of claim 11, wherein the deformation coefficient comprises a scaling coefficient for the key points, and/or a rotation coefficient for the key points.

13. The non-transitory computer readable storage medium of claim 11, wherein obtaining, based on the position information of the adjusted key points, the target key point distribution map comprises:
generating, based on the position information of the adjusted key points, an initial key point distribution map; and
cropping, based on a preset aspect ratio and a preset proportion of a blank area, the initial key point distribution map to obtain the target key point distribution map.

14. The non-transitory computer readable storage medium of claim 11, wherein generating, based at least on the target key point distribution map, the target image according to the preset style comprises:
obtaining constraint condition information for the target object; and
generating, based on the constraint condition information and the target key point distribution map, the target image according to the preset style.

15. The non-transitory computer readable storage medium of claim 14, wherein the constraint condition information comprises one or more of the following: at least one type of specified style information for the target object, contour information corresponding to the target object, skin color information/pelage color information corresponding to the target object, hair color information corresponding to the target object, and a face feature corresponding to the target object.

16. The non-transitory computer readable storage medium of claim 14, wherein generating, based on the constraint condition information and the target key point distribution map, the target image according to the preset style comprises:
extracting a first feature vector of the constraint condition information using a pre-trained first model;
extracting a second feature vector of the target key point distribution map using a pre-trained second model;
combining the first feature vector with the second feature to obtain a combined vector; and
generating the target image using a style diffusion model trained for a preset style and using the combined vector as a conditional vector.

17. An electronic device comprising a memory having executable codes stored thereon, and a processor, wherein the processor, when executing the executable codes, performs an image processing method comprising:
obtaining an original image comprising a target object;
determining, based on the original image, position information of a plurality of key points corresponding to the target object;
obtaining a deformation coefficient that is set for the key points; and
generating, based at least on the position information of the key points and the deformation coefficient, a target image corresponding to the original image according to a preset style, wherein the target image comprises a deformed object generated by performing stylization deformation on the target object.

18. The electronic device of claim 17, wherein the deformation coefficient is used for adjusting a head-to-body ratio corresponding to the target object, and/or a posture corresponding to the target object.

19. The electronic device of claim 17, wherein generating, based at least on the position information of the key points and the deformation coefficient, the target image corresponding to the original image according to the preset style comprises:
adjusting, based on the deformation coefficient, the position information of the key points;
obtaining, based on the position information of the adjusted key points, a target key point distribution map; and
generating, based at least on the target key point distribution map, the target image according to the preset style.

20. The electronic device of claim 19, wherein the deformation coefficient comprises a scaling coefficient for the key points, and/or a rotation coefficient for the key points.
